(19) United States
(12) Patent Application Publication
(10) Pub. No.: US 2011/0217581 A1
(43) Pub. Date: Sep. 8, 2011

(54) CONVERSION OF HEAT TO ELECTRIC ENERGY THROUGH CYCLIC ALTERATION OF SOLUTION

(76) Inventor: Vasilios Styliaras, Patra (GR)

(21) Appl. No.: 13/128,876

(22) PCT Filed: Nov. 12, 2009
(86) PCT No.: PCT/GR09/00061

§ 371 Date: May 12, 2011

(30) Foreign Application Priority Data
Nov. 14, 2008 (GR) 20080100738

(51) Int. Cl. H01M 14/00; H02N 11/00

(52) U.S. Cl. 429/105

(57) ABSTRACT

Conversion of heat to electric energy through cyclic alteration of solutions between two half cells of a galvanic cell. The half cell solutions differ in electrode ion concentration, creating in this way the electrochemical potential of the cell. The solutions are of low solubility electrolytes and part of the electrolyte is separated and transferred from one solution to the other. The method is a cyclic process so that no material consumption takes place. The electrolyte heat of solution is converted to electricity under a high efficiency and using tow temperature heat sources.

This invention refers to electric energy production and heat transfer, using electrochemical elements. There, the term discharge refers to reaction direction when electricity is offered by the cell and the term charge refers to the opposite reaction direction when the cell returns to its original situation. Charging takes place usually by imposing an external voltage of opposite polarity and charging energy equals discharging.

A method has been suggested where different solutions are used for the two processes so that charging and discharging take place in different solutions so that discharging energy is higher than charging and a useful energy results. When the cell works, the electrolyte concentration increases, another electrolyte phase i.e. solid phase, is formed, removed end enters the other solution to dissolve. Next the electrodes are transferred to this solution and it works the opposite direction. The electrolyte is recovered by the electrodes. A long time later, electrodes are transferred to the original solutions. When a cycle is completed, electrodes and solutions have been reformed.

In the present invention, electrolyte separation takes place in both solutions which are enriched in electrode ions. Then an application is presented where only one cell is used the two half cells of which are separated by a semi permeable medium allowing only electrical contact between them and the solutions are of different solvent.

In the first embodiment an electrochemical cell, consisting of two half cells the solutions of which may be separated by an electric conducting or semi permeable medium, has electrodes of different metals dipped in solutions of two sparingly soluble electrolytes (low solubility) the one ion of which is a common ion in both and the other is the ion of the electrode (one electrolyte of the one electrode and the other of the other electrode). Besides one solution of each cell is enriched in one metallic ion and the other solution is saturated with its sparingly soluble electrolyte, so that in each cell the emf of the one electrode is close to nominal and of the other considerably lower because of low ion concentration according to Nerst law. During cell operation one electrode is oxidized and the other is reduced, meaning that the mass of the one is reduced and of the other increased. Since the solution where the low solubility electrolyte is increased, is saturated in this electrolyte, the produced electrolyte forms another phase, is separated and driven to the other cell to be dissolved. This cell works to the opposite direction and ions are deposited on the corresponding electrode. The same but with respect to other sparingly soluble electrolyte takes place in this cell. One or even the two electrodes may be a metal-sparingly soluble salt electrode. During operation, electrode covering takes place instead of electrolyte separation. Heat is absorbed and rejected during crystalization and dissolution at selected temperature levels. Part of this heat is converted to electric energy. Electrolyte crystallization and dissolution may take place through a heat exchanger. equipment

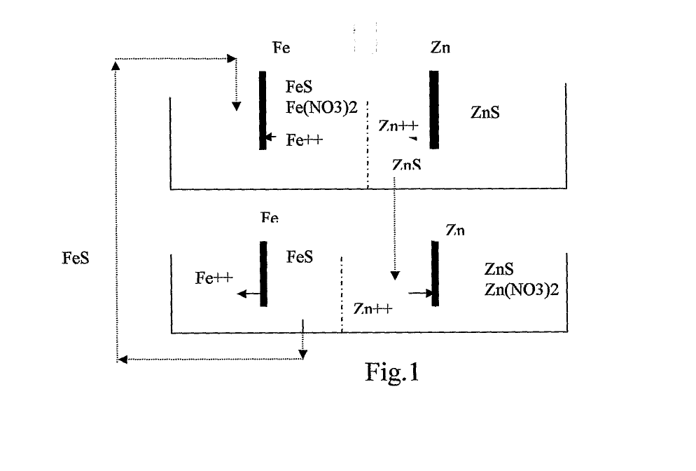

FIG. 1 shows an example where the discharge and charge cells have electrodes of Fe2 and Zn2 dipped in saturated solutions of FeS and ZnS respectively. The first solution of Fe2 half cell is enriched in Fe(NO3)2 and the Zn2 half cell solution of the second cell in Zn(NO3)2. When the cells work, Zn++ ions are released in the first solution and Fe++ ions deposit on the Fe electrode so that ZnS is formed, separated and dissolved in the second cell while FeS is formed in the second cell and dissolved in the first. (Fe+++Zn→Fe+Zn++) The emf of the first cell is −0,44−(−0,76−0,24)=0,6 V and of the second is −0,76−(−0,44−0,2)=−0,12V. (Eo of Fe=−0,44V and Eo of Zn=−0,76V. The emf reduction is calculated from Nerst eq. where ion concentration is estimated by equilibrium constant ksp of sparingly soluble salts. Ksp of ZnS=10⁻²³ , Zn++=10⁻¹¹ ksp of FeS=10⁻¹⁹ , Fe++=10⁻¹⁰ . The second cell works by applying an opposite voltage of 0,12V (charging—consuming electricity). Useful energy ΔG=90 KJ/mole. The operation stops and the electrodes of each cell are moved to the other cell. Instead, the solution of each half cell may be replaced and the second cell is formed in this way. The operation starts again. After a cycle, the electrodes and solutions of each cell are in their original situation.

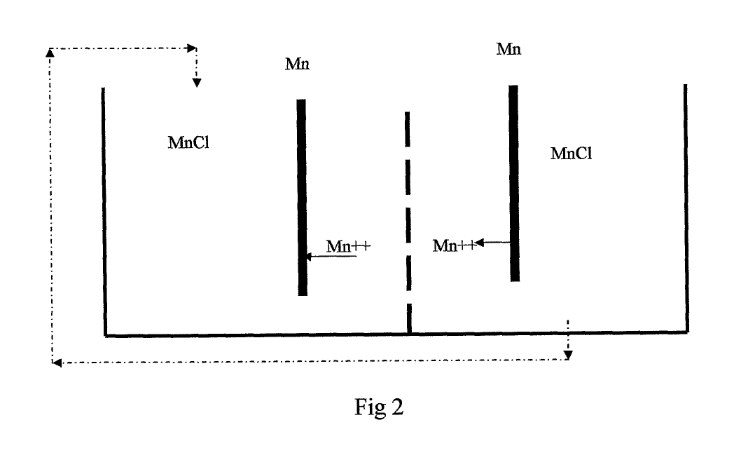

In another embodiment, see FIG. 2, only one cell is used. Its electrodes are of the same material. The solution of each half cell contains the same electrolyte and is separated from the other by a selectively permeable medium allowing only electric contact between the solutions. The solvents of the solutions may be different. The concentration of one of the solutions increases during operation. This solution is saturated in this electrolyte so that the electrolyte forms different phase, is separated and dissolved into the other solution. If sparingly soluble salt is used, one of the solutions may be enriched in ions as above. Because of the difference in solvent and concentration, the emf of each half cell differs, giving a considerable emf of the cell. This combination may give a considerable voltage difference. The electrodes replace each other after a certain operation time. Solutions may change each other instead. In this way the cell produces electricity continuously. The electrodes may be of metal-salt type also as above. They may be a gas electrode too. In this case, gas is circulated outside the cell through a gas pump.

1. A method of producing electric energy using a first half cell and a second half cell, whereby the first half cell includes an electrode made of a material dipped in a saturated liquid solution of at least a low solubility electrolyte comprising the material of the electrode, and the second half cell includes an electrode made of the same material as the electrode of the first half cell dipped in a liquid solution comprising a first electrolyte similar to the said low solubility saturated electrolyte of the first half cell and a soluble electrolyte including the material of the electrode of the second half cell, whereby the method comprises the following steps:
a. establish a circuit between the two half cells,
b. transfer the sediment produced in one half cell to the other half cell,
c. periodically exchange the electrode stripes of the said two half cells.

2. A method of producing electric energy according to claim 1 comprising a first pair of a first half cell and a second half cell and a second pair of a first half cell and a second half cell, whereby the electrodes of the second pair are of different material than the electrodes of the first pair and the first half cell of the first pair and the second half cell of the second pair form a first cell and the second half cell of the first pair and the first half cell of the second pair form a second cell. The electrodes selection is such that the one cell produces electric energy while an opposite voltage is applied to the other, if necessary, to drive the reaction the opposite direction.

3. A method of producing electric energy according to claim 1 where gas electrodes are used and gas released from one electrode feeds the other through a gas pump.

4. Galvanic cell consisted of two half cells having electrodes of the same material, dipped in solutions containing at least a common electrolyte comprising the electrode material and this electrolyte is transferred from the one half cell to the other and their electrodes are periodically exchanged.

5. Heat transfer and electric energy production using a galvanic cell working according to claim 1 where heat is exchanged at two temperature levels related to electrolyte formation and dissolution processes.
